(19) United States
(12) Patent Application Publication
(10) Pub. No.: US 2021/0025200 A1
(43) Pub. Date: Jan. 28, 2021

(54) ELECTRONIC DEVICE LOCK

(71) Applicant: SINOXLOCK (KUNSHAN) CO., LTD, Kunshan (CN)

(72) Inventor: CHIA-MING WU, Kunshan (CN)

(73) Assignee: SINOXLOCK (KUNSHAN) CO., LTD, Kunshan (CN)

(21) Appl. No.: 16/925,768

(22) Filed: Jul. 10, 2020

(30) Foreign Application Priority Data
Jul. 24, 2019 (TW) 108209695

(51) Int. Cl. E05B 73/00; E05B 37/02

(52) U.S. Cl. CPC E05B 73/0082; E05B 37/02

(57) ABSTRACT

An electronic device lock of the present utility model includes a case, a lock module, a lock core, and a driving device. The case has a case opening. An engaging portion is disposed at an inner side of the case. The lock module is detachably disposed in the case, and includes a lock hook group and a locking piece. At least a part of the lock hook group is able to extend out of the case from the case opening. At least a part of the locking piece extends into the lock hook group. The lock core is disposed in the case. The driving device is rotatably disposed in the case, and has a first driving portion and a second driving portion. The first driving portion and the second driving portion are respectively gears meshed with each other. When the lock core is in an unlocked state, the lock core is able to drive the second driving portion to rotate, and the first driving portion linked to the second driving portion is enabled to rotate, so that the locking piece rotates to drive a part of the lock hook group extending out of the case to open, and a part of the lock hook group in the case extends into the engaging portion.

### BACKGROUND

### Technical Field

The present utility model relates to an electronic device lock. Further, the present utility model relates to an electronic device lock configured to lock a notebook computer.

### Related Art

In the modern life, consumer electronic products play an important role. Together with today's rapid lifestyle and people's demands for real-time information, portable electronic products have become one of necessary products for people. However, these products have an increased possibility of being lost or stolen due to their characteristics of high demand, popularity, high unit price, small size, portability, etc.

In order to prevent the products from being stolen by others, a lockset, such as a lock for a notebook computer, is designed. The lock can be connected with an antitheft lock hole of an electronic product through a lock catch piece. For a locking operation of the lockset, the lock catch piece can be locked in the antitheft lock hole in a state that the lock catch piece is connected with the electronic product. However, there are various specifications of antitheft lock holes in the market at present, so that a user must purchase a plurality of locksets with different specifications to be used corresponding to the locksets, and there is a space for improvement in use convenience and economy.

### SUMMARY

An objective of the present utility model is to provide an electronic device lock to solve the above problems in the related art.

The electronic device lock of the present utility model includes a case, a lock module, a lock core, and a driving device. The case has a case opening. An engaging portion is disposed at an inner side of the case. The lock module is detachably disposed in the case, and includes a lock hook group and a locking piece. At least a part of the lock hook group is able to extend out of the case from the case opening. At least a part of the locking piece extends into the lock hook group. The lock core is disposed in the case. The driving device is rotatably disposed in the case, and has a first driving portion and a second driving portion. The first driving portion and the second driving portion are respectively gears meshed with each other. When the lock core is in an unlocked state, the lock core is able to drive the second driving portion to rotate, and the first driving portion linked to the second driving portion is enabled to rotate, so that the locking piece rotates to drive a part of the lock hook group extending out of the case to open, and a part of the lock hook group in the case extends into the engaging portion.

In an embodiment of the present utility model, the lock module is able to be dismounted from the case opening to leave away from the case.

In an embodiment of the present utility model, the lock core includes a lock core stress portion and a lock core driving portion linked to the lock core stress portion. The lock core stress portion is able to be stressed, so that the lock core driving portion drives the part of the lock hook group extending out of the case to open, and the part of the lock hook group in the case extends into the engaging portion.

In an embodiment of the present utility model, the lock module further includes a lock casing. The lock casing has a first opening and a second opening. An engaging hole corresponding to the engaging portion is formed in a side wall of the lock casing. The lock hook group is disposed in the lock casing, and includes two lock hooks. Each lock hook includes a hook portion and an engaging piece. The hook portions extend out of the lock casing from the first opening, and are able to extend out of the case from the case opening. The engaging pieces are able to extend out of the lock casing from the engaging hole and extend into the engaging portion. The locking piece is disposed in the lock casing, and is able to drive the lock portions of the two lock hooks to leave far away from each other and the engaging pieces to extend into the engaging portion.

In an embodiment of the present utility model, the locking piece includes a rotating portion and a flat rod piece. The rotating portion is able to rotate relative to the lock hook group. One end of the rotating portion faces the lock hook group, and the other end is exposed out of the lock casing from the second opening. The flat rod piece extends from the rotating portion toward one end of the lock hook group to a position between the two lock hooks, and is able to be linked to the rotating portion to rotate between the two lock hooks, so that the hook portions of the two lock hooks are driven to leave far away from each other, and the engaging pieces are driven to extend into the engaging portion.

In an embodiment of the present utility model, the first driving portion is engaged and linked with the rotating portion. The lock core driving portion of the lock core is engaged and linked with the second driving portion. When the lock core is in the unlocked state, the lock core stress portion is able to be stressed, so that the lock core driving portion rotates to drive the second driving portion to rotate, the first driving portion linked to the second driving portion is enabled to rotate, and then the rotating portion is driven to rotate, so that the flat rod piece linked to the rotating portion rotates, the hook portions of the two lock hooks leave far away from each other, and the engaging pieces extend into the engaging portion.

In an embodiment of the present utility model, the first driving portion and the rotating portion are respectively provided with a first driving portion concave portion and a rotating portion convex block capable of being correspondingly engaged. The lock core driving portion and the second driving portion are respectively provided with a lock core driving portion convex block and a second driving portion concave portion capable of being correspondingly engaged.

In an embodiment of the present utility model, the lock core is a key lock core.

In an embodiment of the present utility model, the engaging portion is a concave pit.

In an embodiment of the present utility model, an antiskid device is disposed on a peripheral surface of the lock module.

### BRIEF DESCRIPTION OF THE DRAWINGS

FIGS. 1A and 1B are schematic diagrams of embodiments of an electronic device lock of the present utility model.

FIGS. 2A to 3B are schematic diagrams of embodiments of parts of assemblies of the electronic device lock of the present utility model.

FIGS. 4A and 4B are schematic exploded views of embodiments of clamp hooks approaching to each other of the electronic device lock of the present utility model.

FIGS. 5A and 5B are schematic exploded views of embodiments of the clamp hooks leaving far away from each other of the electronic device lock of the present utility model.

FIG. 6A is a schematic cross-sectional view of an embodiment of the clamp hooks approaching to each other and hook portions entering an antitheft lock hole of the electronic device lock of the present utility model.

FIG. 6B is a schematic cross-sectional view of a different embodiment of the electronic device lock of the present utility model.

FIG. 6C is a schematic cross-sectional view of an embodiment of the clamp hooks leaving far away from each other and the hook portions entering the antitheft lock hole of the electronic device lock of the present utility model.

FIG. 7 is a schematic cross-sectional view of a different embodiment of the electronic device lock of the present utility model.

### DETAILED DESCRIPTION

An electronic device lock of the present utility model is preferably configured to lock a notebook computer, and is more specifically locked in a lock hole of the notebook computer. However, in different embodiments, the electronic device lock may also be configured to lock other electronic devices with lock holes.

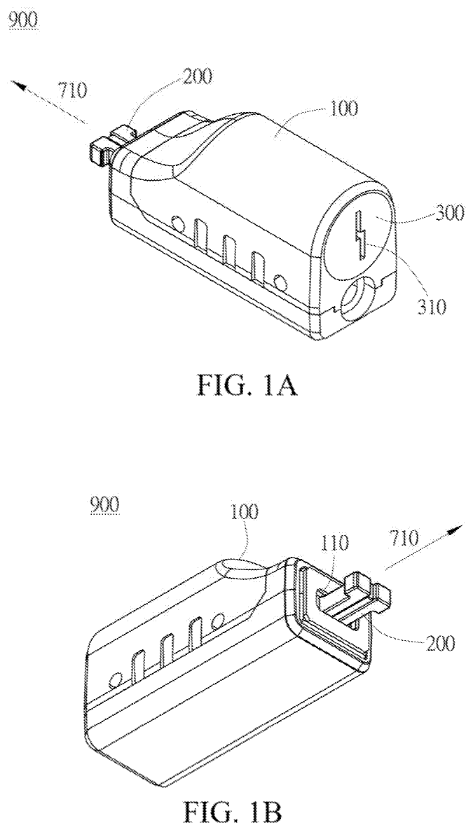

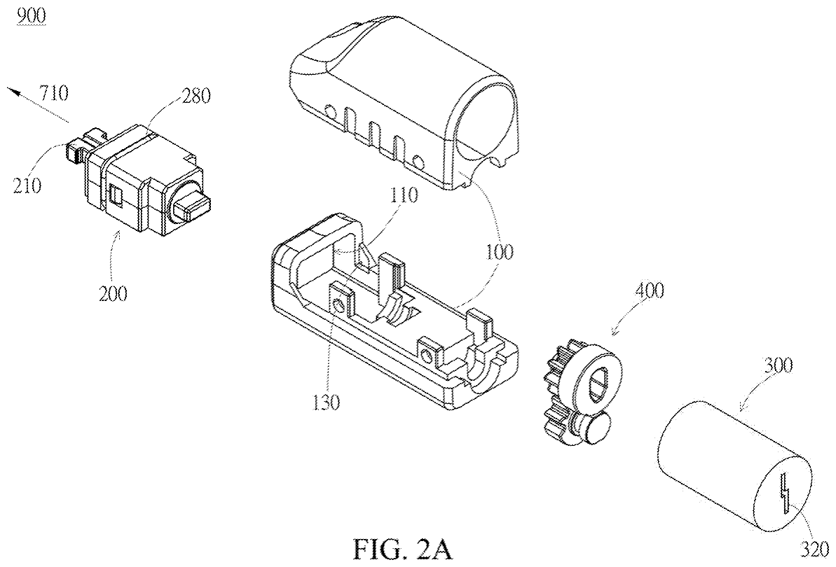

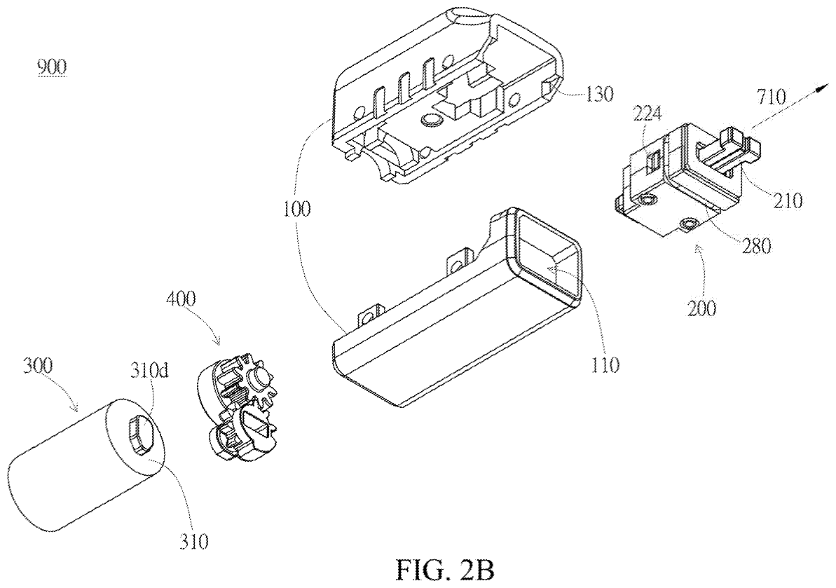

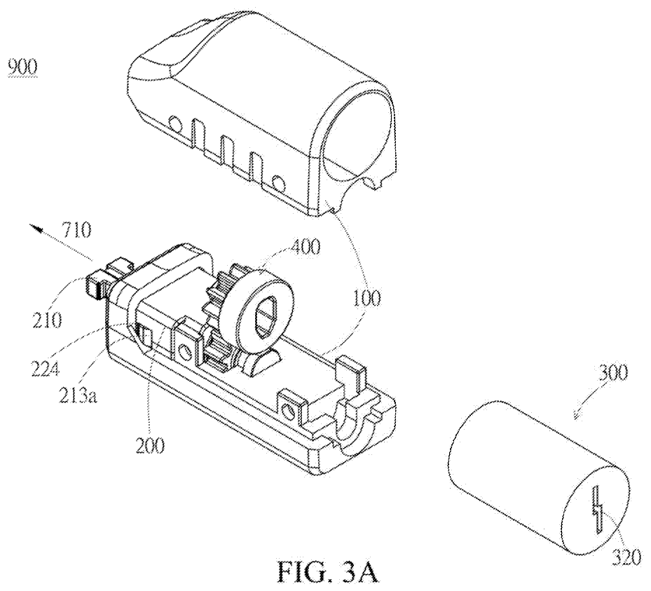

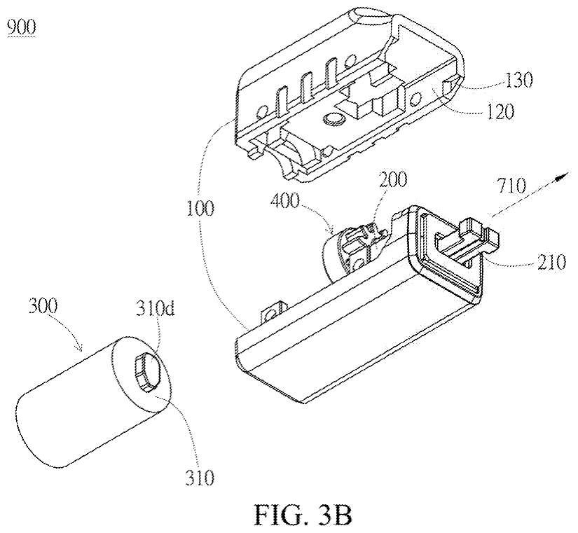

According to embodiments shown in FIGS. 1A to 3B, an electronic device lock 900 of the present utility model includes a case 100, a lock module 200, a lock core 300, and a driving device 400. The case 100 has a case opening 110. Engaging portions 130 are disposed at an inner side 120 of the case 100. The engaging portions 130 are preferably concave pits. However, in different embodiments, the engaging portions may also be through holes or other structures with engaging effects.

According to the embodiments shown in FIGS. 1A to 3B, the lock module 200 is detachably disposed in the case 100. More specifically, the lock module 200 is able to be dismounted in a direction 710 from the case opening 110 to leave away from the case 100. The lock module 200 is able to be remained in the case 100 through friction between its peripheral surface and the inner side 120 of the case 100. Additionally, an antiskid device 280 such as a rubber ring may be further disposed on the peripheral surface of the lock module 200 so as to increase the friction between the lock module 200 and the inner side 120 of the case 100 and reduce a probability of the lock module 200 freely sliding out of the case 100.

According to the embodiments shown in FIGS. 1A to 3B, the lock module 200 includes a lock hook group 210 and a locking piece 230. At least a part of the lock hook group 210 is able to extend out of the case 100 from the case opening 110. At least a part of the locking piece 230 extends into the lock hook group 210. The lock core 300 is disposed in the case 100, and includes a lock core driving portion 310 and a lock core stress portion 320 which are linked to each other. The driving device 400 is rotatably disposed in the case 100, and has a first driving portion 410 and a second driving portion 420. The first driving portion 410 and the second driving portion 420 are respectively gears meshed with each other. When the lock core 300 is in an unlocked state, the lock core 300 is able to drive the second driving portion 420 to rotate, and the first driving portion 410 linked to the second driving portion 420 is enabled to rotate, so that the locking piece 230 rotates to drive a part of the lock hook group 210 extending out of the case 100 to open, and a part of the lock hook group 210 in the case 100 extends into the engaging portions 130.

Further, in the present embodiment, the lock core 300 is a key lock core. The lock core driving portion 310 is a convex portion. The lock core stress portion 320 is a key hole. When the lock core 300 is in the unlocked state, a user can insert a key into the lock core stress portion 320 to exert force on the lock core 300 to make it rotate. That is, the lock core stress portion 320 is able to be stressed so that the lock core driving portion 310 is linked to rotate. Additionally, the lock core driving portion 310 drives the part of the lock hook group 210 extending out of the case 100 to open, the part of the lock hook group 210 in the case 100 extends into the engaging portions 130, and it is described in detail below. In different embodiments, by considering design, manufacturing, or use requirements, the lock core 300 may have different configurations. For example, the lock core 300 may be a number lock core. The lock core driving portion may be a convex portion or a structure with an engaging effect. The lock core stress portion may be a knob or a press key.

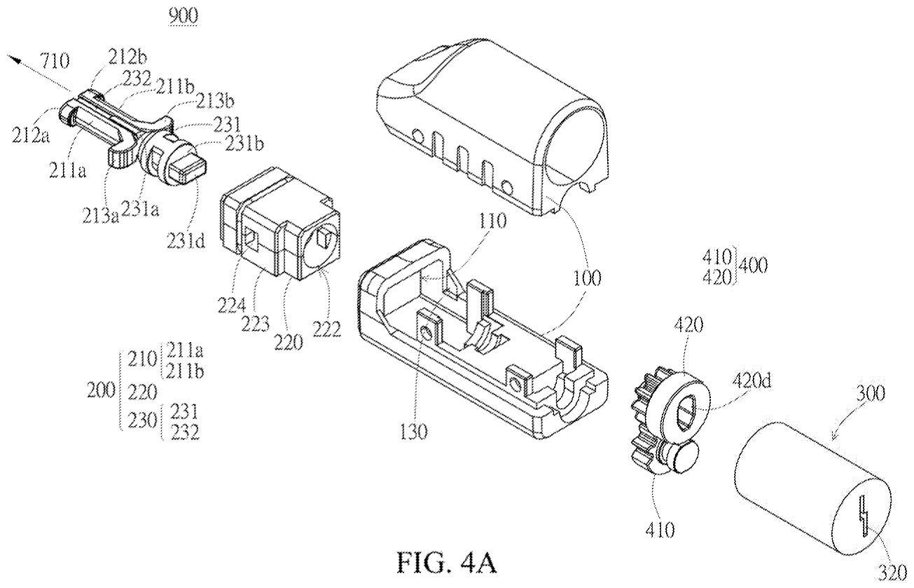

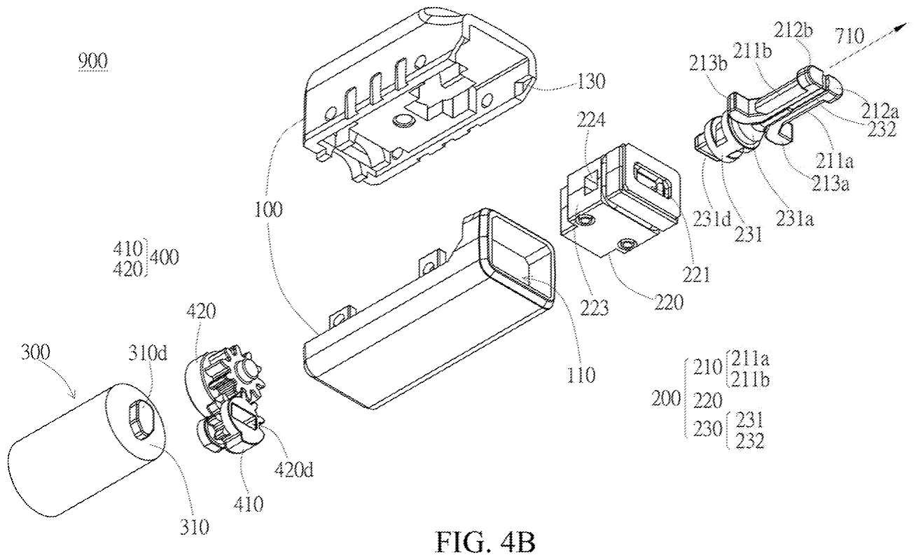

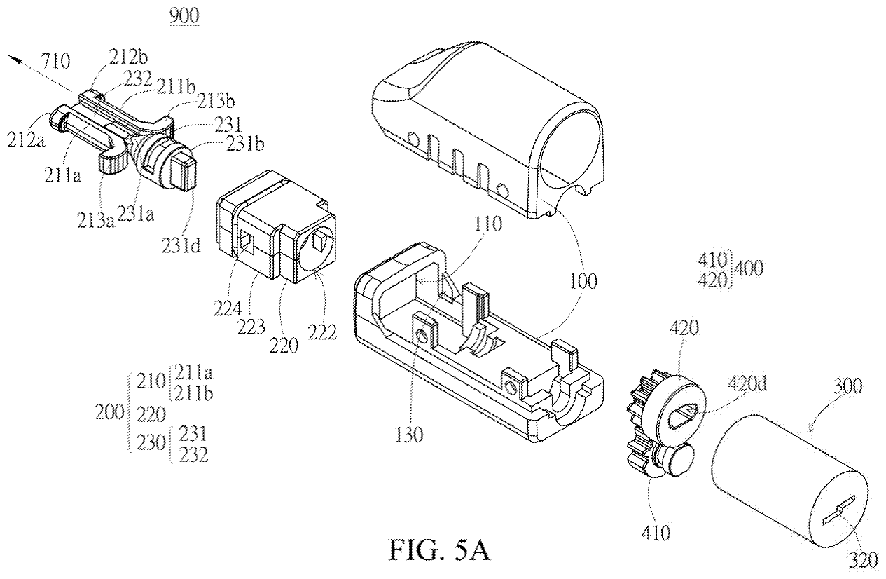

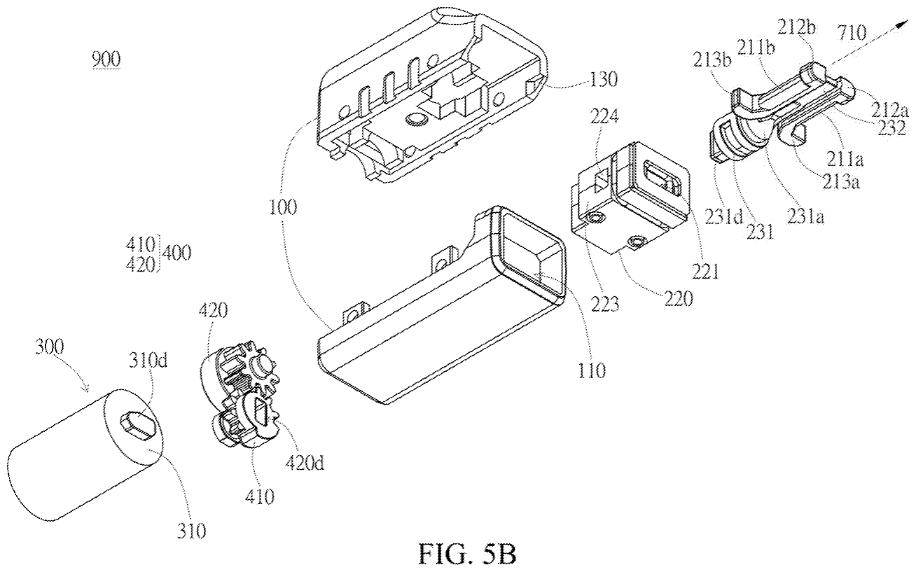

More specifically, according to embodiments shown in FIGS. 4A to 5B, the lock module 200 preferably further includes a lock casing 220. The lock casing 220 has a first opening 221 and a second opening 222. Engaging holes 224 corresponding to the engaging portions 130 are formed in side walls 223 of the lock casing 220. The lock hook group 210 is disposed in the lock casing 220, and includes two lock hooks 211a and 211b. The lock hooks 211a and 211b include hook portions 212a and 212b and engaging pieces 213a and 213b. The hook portions 212a and 212b extend out of the lock casing 220 from the first opening 221, and are able to extend out of the case 100 from the case opening 110 (referring to FIGS. 1A and 1B). The engaging pieces 213a and 213b are able to extend out of the lock casing 220 from the engaging holes 224, and extend into the engaging portions 130. The locking piece 230 is disposed in the lock casing 220, and is able to drive the lock portions 212a and 212b of the two lock hooks 211a and 211b to leave far away from each other and the engaging pieces 213a and 213b to extend into the engaging portions 130.

According to the embodiments shown in FIGS. 4A to 5B, the locking piece 230 includes a rotating portion 231 and a flat rod piece 232. The rotating portion 231 is able to rotate relative to the lock hook group 210. One end 231a of the rotating portion 231 faces the lock hook group 210, and the other end 231b is exposed out of the lock casing 220 from the second opening 222. The flat rod piece 232 extends from the rotating portion 231 toward one end of the lock hook group 210 to a position between the two lock hooks 211a and 211b, and is able to be linked to the rotating portion 231 to rotate between the two lock hooks 211a and 211b, so that the hook portions 212a and 212b of the two lock hooks 211a and 211b are driven to leave far away from each other, and the engaging pieces 213a and 213b are driven to extend into the engaging portions 130, as shown in FIGS. 5A and 5B.

According to the embodiments shown in FIGS. 4A to 5B, the first driving portion 410 is engaged and linked with the rotating portion 231. The lock core driving portion 310 of the lock core 300 is engaged and linked with the second driving portion 420. Further, the first driving portion 410 and the rotating portion 231 are respectively provided with a first driving portion concave portion 410d and a rotating portion convex block 231d capable of being correspondingly engaged. The lock core driving portion 310 and the second driving portion 420 are respectively provided with a lock core driving portion convex block 310d and a second driving portion concave portion 420d capable of being correspondingly engaged.

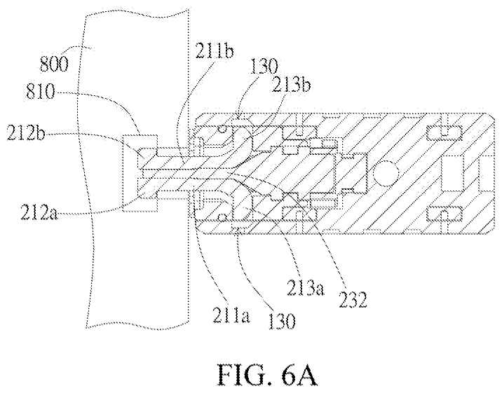

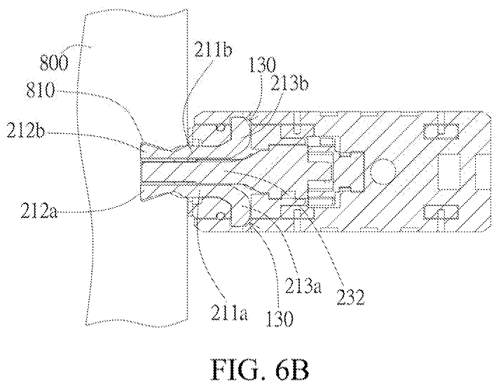

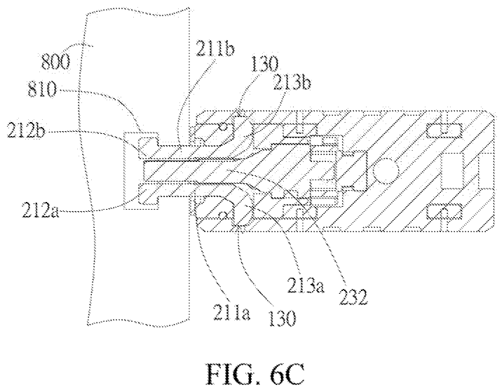

More specifically, when the lock core 300 is in the unlocked state, the lock core stress portion 320 is able to be stressed to enable the lock core driving portion 310 to rotate. The second driving portion 420 is driven to rotate. The first driving portion 410 linked to the second driving portion 420 is enabled to rotate. Then, the rotating portion 231 is driven to rotate. Therefore, the flat rod piece 232 linked to the rotating portion 231 rotates. According to embodiments shown in FIGS. 4A, 4B, and 6A, when the flat rod piece 232 rotates to a state that a wide surface faces the two lock hooks 211a and 211b, that is, the flat rod piece 232 vertically stands between the two lock hooks 211a and 211b, the hook portions 212a and 212b of the two lock hooks 211a and 211b approach to each other, and the engaging pieces 213a and 213b do not extend into the engaging portions 130. At the moment, the user can extend the hook portions 212a and 212b into an antitheft lock hole 810 of an electronic device 800 as shown in FIG. 6A. On the other hand, the engaging pieces 213a and 213b do not extend into the engaging portions 130, so that the user can dismount the lock module 200 from the case opening 110 to leave away from the case 100 according to requirements (for example, for the antitheft lock holes in different sizes as shown in FIG. 6B). A required lock module 200 is replaced, and repurchase of a whole set of electronic device lock is not needed, so that the use convenience and economy can be improved.

Then, if the user wants to lock the electronic device lock 900 in the antitheft lock hole 810 of the electronic device 800, the flat rod piece 232 can be rotated to a state that a narrow surface faces the two lock hooks 211a and 211b as shown in FIGS. 5A, 5B, and 6C, that is, the flat rod piece 232 is transversely put between the two lock hooks 211a and 211b, so that the hook portions 212a and 212b of the two lock hooks 211a and 211b leave far away from each other, and the engaging pieces 213a and 213b extend into the engaging portions 130. At the moment, if the user sets the lock core 300 into a locked state, the rotation of the flat rod piece 232 is limited, and the lock portions 212a and 212b keep being engaged at the side walls of the antitheft lock hole 810 as shown in FIG. 6C, so that the electronic device lock 900 is locked on the electronic device 800. On the other hand, in this state, the engaging pieces 213a and 213b have extended into the engaging portions 130, so that movement of the lock module 200 relative to the case 100 is limited, and the lock module cannot leave away from the case 100 from the case opening 110.

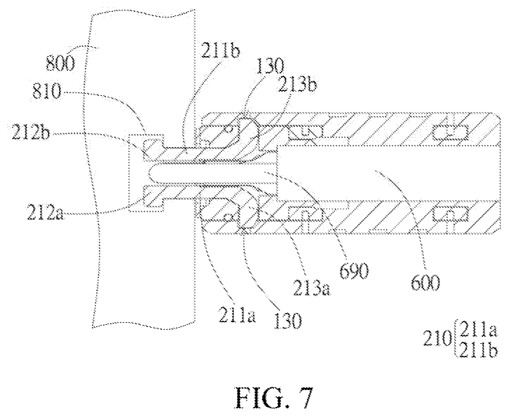

In different embodiments, by considering design, manufacturing, or use requirements, the locking piece and the driving device may have different configurations. According to an embodiment shown in FIG. 7, the lock core 600 may be a number lock with a lock shaft rod 690. The lock shaft rod 690 can move towards the lock hook group 210 to reach a position between the two lock hooks 211a and 211b so as to drive the hook portions 212a and 212b of the two lock hooks 211a and 211b to leave far away from each other and the engaging pieces 213a and 213b to extend into the engaging portions 130.

Although the foregoing description and drawings have disclosed exemplary embodiments of the present utility model, it should be understood that various additions, many modifications, and substitutions may be made thereto without departing from the spirit and scope of the principles of the present utility model as defined by the appended claims. Those ordinarily skilled in the art of the present utility model will appreciate that the present utility model is applicable to modifications of many forms, structures, arrangements, proportions, materials, components, and components. Therefore, the embodiments disclosed herein should be considered as illustrative and not restrictive of the present utility model. The scope of the present utility model should be defined by the appended claims, and covers the legal equivalents thereof, but is not limited to the foregoing descriptions.

### LIST OF REFERENCE NUMERALS

100 case

110 case opening

120 inner side

130 engaging portion

200 lock module

210 lock hook group

211a lock hook

211b lock hook

212a hook portion

212b hook portion

213a engaging piece

213b engaging piece

220 lock casing

221 first opening

222 second opening;

223 side wall

224 engaging hole

230 locking piece

231 rotating portion

231a end

231b end

231d rotating portion convex block

232 flat rod piece

280 antiskid device

300 lock core

310 lock core driving portion

310d lock core driving portion convex block

320 lock core stress portion

400 driving device

410 first driving portion

410d first driving portion concave portion

420 second driving portion

420d second driving portion concave portion

690 lock shaft rod

710 direction

800 electronic device

810 antitheft lock hole

900 electronic device lock

What is claimed is:

1. An electronic device lock, comprising:
a case, having a case opening, wherein an engaging portion is disposed at an inner side of the case;
a lock module, detachably disposed in the case and comprising a lock hook group and a locking piece, wherein at least a part of the lock hook group is able to extend out of the case from the case opening, and at least a part of the locking piece extends into the lock hook group;
a lock core, disposed in the case; and
a driving device, rotatably disposed in the case and having a first driving portion and a second driving portion, wherein the first driving portion and the second driving portion are respectively gears meshed with each other;
when the lock core is in an unlocked state, the lock core is able to drive the second driving portion to rotate, and the first driving portion linked to the second driving portion is enabled to rotate, so that the locking piece rotates to drive a part of the lock hook group extending out of the case to open, and a part of the lock hook group in the case extends into the engaging portion.

2. The electronic device lock according to claim 1, wherein the lock module is able to be dismounted from the case opening to leave away from the case.

3. The electronic device lock according to claim 1, wherein the lock core comprises a lock core stress portion and a lock core driving portion linked to the lock core stress portion, the lock core stress portion is able to be stressed, so that the lock core driving portion drives the part of the lock hook group extending out of the case to open, and the part of the lock hook group in the case extends into the engaging portion.

4. The electronic device lock according to claim 3, wherein:
the lock module further comprises a lock casing,
the lock casing has a first opening and a second opening, and an engaging hole corresponding to the engaging portion is formed in a side wall of the lock casing;
the lock hook group is disposed in the lock casing, and comprises two lock hooks, and each lock hook comprises:
a hook portion, extending out of the lock casing from the first opening, and being able to extend out of the case from the case opening; and
an engaging piece, being able to extend out of the lock casing from the engaging hole and extend into the engaging portion; and
the locking piece is disposed in the lock casing, and is able to drive the lock portions of the two lock hooks to leave far away from each other and the engaging pieces to extend into the engaging portion.

5. The electronic device lock according to claim 4, wherein the locking piece comprises:
a rotating portion, being able to rotate relative to the lock hook group, wherein one end of the rotating portion faces the lock hook group, and the other end is exposed out of the lock casing from the second opening; and
a flat rod piece, extending from the rotating portion toward one end of the lock hook group to a position between the two lock hooks, and being able to be linked to the rotating portion to rotate between the two lock hooks, so that the hook portions of the two lock hooks are driven to leave far away from each other, and the engaging pieces are driven to extend into the engaging portion.

6. The electronic device lock according to claim 5, wherein the first driving portion is engaged and linked with the rotating portion, and the lock core driving portion of the lock core is engaged and linked with the second driving portion; and
when the lock core is in the unlocked state, the lock core stress portion is able to be stressed, so that the lock core driving portion rotates to drive the second driving portion to rotate, the first driving portion linked to the second driving portion is enabled to rotate, and then the rotating portion is driven to rotate, so that the flat rod piece linked to the rotating portion rotates, the hook portions of the two lock hooks leave far away from each other, and the engaging pieces extend into the engaging portion.

7. The electronic device lock according to claim 6, wherein the first driving portion and the rotating portion are respectively provided with a first driving portion concave portion and a rotating portion convex block capable of being correspondingly engaged, and the lock core driving portion and the second driving portion are respectively provided with a lock core driving portion convex block and a second driving portion concave portion capable of being correspondingly engaged.

8. The electronic device lock according to claim 1, wherein the lock core is a key lock core.

9. The electronic device lock according to claim 1, wherein the engaging portion is a concave pit.

10. The electronic device lock according to claim 1, wherein an antiskid device is disposed on a peripheral surface of the lock module.
